(19) United States
(12) Patent Application Publication
(10) Pub. No.: US 2007/0281575 A1
(43) Pub. Date: Dec. 6, 2007

(54) Method for producing organic EL display panel

(75) Inventors: Koji Takeshita, Tokyo (JP); Takahisa Shimizu, Tokyo (JP); Hironori Kawakami, Tokyo (JP); Nahoko Inokuchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/732,757

(22) Filed: Apr. 3, 2007

(30) Foreign Application Priority Data
May 12, 2006 (JP) 2006-133842

(51) Int. Cl. H05B 33/02

(52) U.S. Cl. 445/58

(57) ABSTRACT

It is intended to provide an organic EL display panel production method which enables formation of light emitting layers by a relief printing process in an organic EL display having RGB arrangement in a delta alignment or a mosaic alignment. A relief plate (resin relief plate) 50 in this invention has projections 202 in the form of dots corresponding to arrangement of pixels P for one of the colors in accordance with the pixels P of which R, G, and B are arranged in the delta alignment. A resin relief plate 16 has projections 202 in the form of dots corresponding to the pixels P for any one of the colors among the pixels P corresponding to R, G, and B, and an area S2 of an apical surface of each of the projections 202 is 70% to 90% of an area S1 of a bottom surface of an aperture P1 of each of the pixels P.

### CROSS REFERENCE

This application claims priority to Japanese patent application number 2006-133842, filed on May 12, 2006, which is incorporated by reference.

### BACKGROUND OF THE INVENTION

1. Field of the Invention

This invention relates to a method for producing an organic EL display of which an organic light emitting layer is made from a high molecular material and, particularly, to a method for producing an organic EL display panel wherein an organic light emitting layer is formed by a printing process.

2. Description of the Related Art

An organic EL element emits light when a current is supplied to a light emitting layer which is formed from an organic light emitting material and between two opposed electrodes, and, in order to achieve efficient light emission, it is important to keep a film thickness of the light emitting layer to about 100 nm. Further, in the case of forming a display from the organic EL element, it is necessary to perform patterning on the organic EL element with high definition.

As the organic light emitting material for forming the light emitting layer, a low molecular material and a high molecular material are usable. The low molecular material is subjected to resistive heating vapor deposition and the like to form a thin film, and at the same time the patterning is performed by using a microscopically patterned mask. However, this method has a problem that patterning accuracy is reduced with an increase in size of a substrate.

Therefore, the high molecular material has recently been used as the organic light emitting material, and a method of forming a thin film by wet coating with a coating liquid obtained by dispersing or dissolving the organic light emitting material into a solvent has been tried.

As the wet coating method for the thin film formation, spin coating, bar coating, projection coating, dip coating, and the like are known. However, the wet coating methods have difficulty in realizing the high definition patterning and color coding with R, G, and B, and it is considered that the thin film is most effectively formed by a printing process that is capable of achieving excellent color coding and patterning.

Further, among various printing processes, the gravure printing and like methods wherein a hard plate such as a metal printing plate is used are not suitable for the organic EL element and display that have a glass substrate. The offset printing using an elastic rubber blanket and a relief process using an elastic rubber plate or resin plate are appropriate for the organic EL element and display. As attempts on the printing processes, a method employing the offset printing (see Patent Publication 1) and a method employing the relief process (see Patent Publication 2) and so on have been proposed.

Meanwhile, the high molecular organic light emitting material has a low solubility to water and alcohol-based solvents, and it is necessary to use an organic solvent for obtaining a coating liquid (hereinafter referred to as ink) from the high molecular organic light emitting material. As the organic solvent, toluene, xylene, and the like are suitably used. Therefore, the ink made from the organic light emitting material (hereinafter referred to as organic EL ink) is an ink of organic solvent.

However, the rubber blanket used in the offset printing is subject to swelling and deformation due to the toluene or xylene organic solvent. Though various rubbers such as an olefin-based rubber and a silicone-based rubber are usable for the blanket, the rubbers do not have resistance to the toluene solvent, the xylene solvent, and the like and are subject to swelling and deformation. Therefore, the rubbers are inadequate for printing the organic EL ink.

Also, a flexographic printing process using a plate made from a rubber and a resin relief process using a resin plate are included in the relief process using an elastic relief plate, and a process using a water-developable resin relief plate is highly resistant to the toluene solvent, the xylene solvent, and other organic solvents and usable for the organic EL ink printing.

From the above reasons, the relief process using the water-developable resin relief plate is the most suitable as the method of printing the organic EL ink made from the aromatic solvent such as toluene and xylene on the hard substrate such as the glass substrate.

As an alignment of R, G, and B constituting pixels of a full color display of active matrix type, a stripe alignment, a delta alignment, a mosaic alignment, and the like are known. Since displays which mainly display letters and numeric characters, such as a display of a personal computer or the like, are capable of displaying linear images without causing strangeness when the stripe alignment is employed, the stripe alignment is not problematic at all for such displays.

However, in displays which mainly display various types of images, particularly dynamic images, such as a display of a television, the delta alignment or the mosaic alignment are preferred since they are capable of displaying smoother images. Therefore, in the case of using the organic EL display for the displays displaying dynamic images such as the television display, it is preferable to align R, G, and B in the delta alignment or the mosaic alignment.

In the case of forming the light emitting layer of the organic EL display by color coding R, G, and B with high positional accuracy by the printing process, the light emitting layer has been printed in the form of stripes on the pixels on the stripes in a passive matrix type, and, likewise, the light emitting layer has been printed in the form of stripes in the active matrix wherein R, G, and B are aligned linearly in the form of stripes.

However, since the pixels of identical color are not aligned in the form of a stripe in the delta alignment and the mosaic alignment, it is impossible to print the light emitting layer in the form of stripes, and it is necessary to perform a so-called dot printing process wherein the light emitting layer is printed on each of the pixels.

In general, in the case of printing the light emitting layer in the form of stripes by the relief process or the like, the positioning of a printing direction is advantageously facilitated by adjusting a direction of extension of lines of strips to the printing direction. However, since it is necessary to highly accurately position in the printing direction in the dot printing process, it is difficult to improve the printing accuracy.

As descried in the foregoing, the light emitting layer formation by the printing process using the high molecular organic light emitting ink provides the potential for realizing a large size substrate, and, as a result of extensive researches, we have found that it is possible to form the light emitting layer by the printing process by using a water-developable photosensitive resin relief plate.

Also, as described in the foregoing, too, it is preferable to employ the delta alignment or the mosaic alignment for the RGB alignment of the display displaying various images as dynamic images, such as the RGB alignment of the television display. In the case of forming the light emitting layer for such RGB alignment by the printing process, it is necessary to employ a printing process for printing in a dot form on each of pixels.

Also, as described in the foregoing, too, in the case of printing in the dot form, it is necessary to perform the highly accurate positioning in the printing direction in addition to the positioning in a direction perpendicular to the printing direction. However, for the printing direction positioning, it is necessary to consider alignment work for simply aligning a plate and a substrate to be printed, a curvature of a relief plate wound around a printing cylinder drum, and a peripheral velocity difference between an elastic plate compressed due to a printing pressure and the substrate, thereby making the positioning work remarkably difficult.

In the relief plate printing process in the dot form, when a part of dots of a relief plate overlaps on a partition due to a slight shift of a printing position, an amount of an ink to be transferred to pixels is reduced to reduce a film thickness of light emitting layers in the pixels. Even when a defect is avoided by supplying the ink to the pixels by leveling, such reduced film thickness is still problematic.

This invention has been accomplished in order to solve the above-described problems in the conventional technologies, and an object thereof is to provide a dot printing process which enables easy positioning adjustment in a printing direction, more specifically, to provide an organic EL display panel production method which enables formation of a light emitting layer by a relief process even in the case where an organic EL display has RGB arrangement in a delta alignment or a mosaic alignment.

[Patent Publication 1] JP-A-2001-93668

[Patent Publication 2] JP-A-2001-155858

### SUMMARY OF THE INVENTION

It is intended to provide an organic EL display panel production method which enables formation of a light emitting layer by a relief process in an organic EL display wherein RGB alignment is a delta alignment or a mosaic alignment. A relief plate (resin relief plate) 50 of this invention has projections 202 in the form of dots which are formed in accordance with pixels P of which R, G, and B are arranged in the delta alignment, the projections 202 corresponding to the alignment for one of the colors. A resin relief plate 16 has projections 202 in the form of dots corresponding to the pixels P for any one of the colors among the pixels P corresponding to R, G, and B, and an area S2 of an apical surface of each of the projections 202 is 70% to 90% of an area S1 of a bottom surface of an aperture P1 of each of the pixels P.

### BRIEF DESCRIPTION OF THE DRAWINGS

FIG. 1 is an illustrative sectional view showing an organic EL display panel.

FIG. 2 is an illustrative sectional view showing a TFT substrate 1.

FIG. 3 is a diagram showing an alignment of pixels, wherein (a) shows a stripe alignment, (b) shows a mosaic alignment, and (c) shows a delta alignment.

FIG. 4 is an illustration of a positional relationship between the pixel alignment and projections (dots) of a relief plate in the delta alignment.

FIG. 5 is an illustrative sectional view showing the relief plate and the TFT substrate.

FIG. 6 is an illustrative sectional view showing a resin relief plate 16 of this invention.

FIG. 7 is an illustrative sectional view illustrating a production method for the resin relief plate.

FIG. 8 is a schematic diagram showing a relief printing press.

### DESCRIPTION OF REFERENCE NUMERALS

1: TFT substrate, 7: partition, 14a: organic light emitting ink, 202: projection, P: pixel, P1: aperture of pixel, 41: red organic light emitting layer, 42: green organic light emitting layer, 43: blue organic light emitting layer.

### DESCRIPTION OF THE PREFERRED EMBODIMENTS

Hereinafter, embodiments of this invention will be described with reference to the drawings. In this embodiment, one example of producing an organic EL display panel of active matrix type wherein R, G, and B are arranged in a delta alignment will be described.

First, a structure of the organic EL display panel will be described.

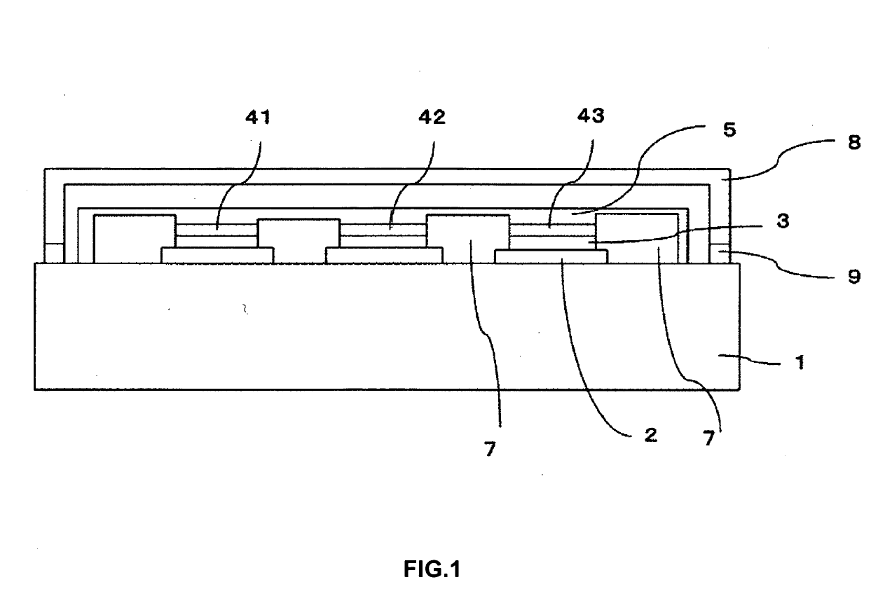

Shown in FIG. 1 is an illustrative sectional view of the organic EL display panel.

This invention is applicable to organic EL display panels of active matrix method. The active matrix method is a method for causing each of pixels to independently emit light by using a so-called thin film transistor (TFT) substrate wherein the transistor is formed for each of the pixels.

As shown in FIG. 1, the organic EL display panel has first electrodes 2 which are formed on the TFT substrate 1 as anodes. Each of partitions 7 is formed between the adjacent first electrodes 2, and it is preferable that the partition 7 covers end portions of the first electrodes 2 for the purpose of preventing short due to burr or the like at the end portions of the first electrodes 2.

The organic EL display panel has an organic light emitting layer and a light emitting auxiliary layer in a region (light emitting region L, pixel portion) above each of the first electrodes 2 and defined by the partitions 7. The layer sandwiched between the adjacent electrodes may be formed only from the organic light emitting layer or may be formed from a stack structure of the organic light emitting layer and the light emitting auxiliary layer. As the light emitting auxiliary layer, a positive hole transport layer, a positive hole injection layer, an electron transport layer, and an electron injection layer are known. Shown in FIG. 1 is a structure formed of a stack structure of a positive hole transport layer 3 serving as the light emitting auxiliary layer and the organic light emitting layer (41, 42, 43). The positive hole transport layers 3 are formed on the first electrodes 2, and each of the positive hole transport layers 3 is provided with the red (R) organic light emitting layer 41, the green (G) organic light emitting layer 42, or the blue (B) organic light emitting layer 43. In this embodiment, the light emitting layer of the scope of claims is formed of the three organic light emitting layers 41, 42, and 43.

Next, a second electrode 5 is disposed on the organic light emitting medium layer as cathode (cathode layer) in such a fashion as to oppose to the first electrodes 2 serving as the anodes. The second electrode 5 is formed on whole surface of the organic EL display panel. Further, in order to prevent intrusion of ambient moisture and oxygen into the first electrodes 2, the organic light emitting layers 41, 42, and 43, the light emitting auxiliary layers, and the second electrodes 5, a sealing body such as a glass cap 8 is provided on all of effective pixels to be stacked with the TFT substrate 1 with an adhesive agent 9.

Hereinafter, the TFT substrate 1 will be described.

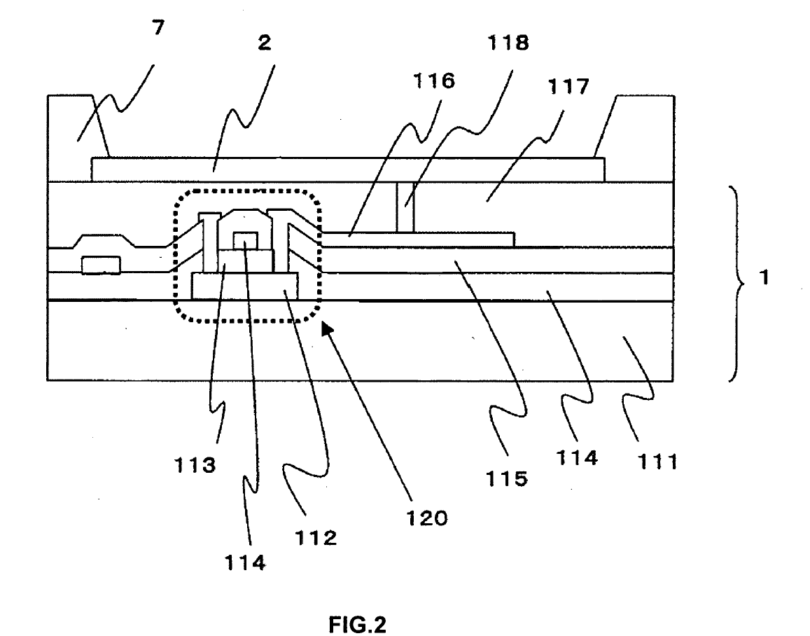

FIG. 2 is an illustrative sectional view of the TFT substrate 1.

The TFT substrate 1 may preferably have such a structure that: a flattening layer 117 is formed on the TFT (thin film transistor) 120; the lower electrode (first electrode 2) of the organic EL display panel is provided on the flattening layer 117; and the TFT 120 and the lower electrode are electrically connected to each other via a contact hole 118 provided on the flattening layer 117. With such a structure, it is possible to achieve excellent electrical insulation between the TFT 120 and the organic light emitting medium layers (positive hole transport layer 3, organic light emitting layers 41, 42, 43).

The TFT 120 and members formed above the TFT 120 are supported by a support 111. The support may preferably be excellent in mechanical strength and dimensional stability.

As a material for the support 111, a glass substrate and a quartz substrate, for example, are usable. Also, a plastic film or sheet made from polypropylene, polyethersulfone, polycarbonate, a cycloolefin polymer, polyallylate, polyamide, polymethylmethacrylate, polyethylenetelephthalate, polyethylenenaphthalate, and the like may be used. Further, for the purpose of preventing intrusion of moisture into the organic light emitting medium layers, those obtained by stacking a metal oxide thin film, a metal fluoride thin film, a metal nitride thin film, a metal oxynitride thin film, or a polymer resin film on the plastic film or sheet may be used.

The support 111 may preferably be reduced in moisture that is absorbed inside the support 111 or on a surface of the support 111 as much as possible by performing a heat treatment before use. Also, depending on a material to be stacked on the support 111, it is preferable to subject the support 111 to a surface treatment such as supersonic cleaning, a Colona discharge, a plasma treatment, and a UV ozone treatment for the purpose of improving adhesion before use.

As the TFT 120 provided on the support 111, a known thin film transistor may be used. More specifically, major examples of the thin film transistor include those formed of an active layer on which a source/drain region and a channel region are formed, a gate insulating film, and a gate electrode. Structure of the thin film transistor is not particularly limited, and examples thereof include a stagger type, an inverted stagger type, a top gate type, a coplanar type, and the like.

The active layer 112 is not particularly limited and may be formed from amorphous silicon, polycrystalline silicon, microcrystalline silicon, an inorganic semiconductor material such as cadmium selenide, or an organic semiconductor material such as thiophene oligomer and poly(p-phenylenevinylene).

It is possible to obtain the active layer by: a method of stacking amorphous silicon by plasma CVD and then performing ion doping; a method of forming amorphous silicon by LPCVD using a SiH₄ gas, followed by obtaining polysilicon by crystallizing the amorphous silicon by a solid phase growth method, and then performing ion doping by an ion implantation method; a method of forming amorphous silicon by LPCVD using a Si₂H₆ gas or by PECVD using a SiH₄ gas, followed by obtaining polysilicon by crystallizing the amorphous silicon by annealing with laser such as an excimer laser, and then performing ion doping by an ion doping method (low temperature process); a method of stacking polysilicon by low pressure CVD or LPCVD, followed by forming a gate insulating film by thermal oxidation at 1,000° C. or more, and then forming a n+ polysilicon gate electrode 114 on the gate insulating film, followed by performing ion doping by an ion implantation method (high temperature process); and the like.

As the gate insulating film 113, those typically used as the gate insulating film are usable, and SiO₂ formed by PECVD, LPCVD, or the like, SiO₂ obtainable by thermally oxidizing a polysilicon film, and the like may be used.

As the gate electrode 114, those typically used as the gate electrode are usable, and examples thereof include a metal such as aluminum and copper; a high melting point metal such as titanium, tantalum, and tungsten; polysilicon; silicide and polycide of a high melting point metal; and the like.

The TFT 120 may have a single gate structure, a double gate structure, or a multigate structure having three or more gate electrodes. Also, an LDD structure or an offset structure may be adopted. Further, two or more thin film transistors may be disposed in one pixel.

It is necessary to connect the thin film transistor (TFT) as a switching element of the organic EL display panel, and the drain electrode 116 of the transistor is electrically connected to the pixel electrode (first electrode 2) of the organic EL display panel. Further, it is generally necessary to use a light-reflecting metal for the pixel electrode for achieving the top emission structure.

Connection of the TFT 120, the drain electrode 116, and the pixel electrode (first electrode 2) of the organic EL display panel is established via a connection wiring formed in a contact hole 118 penetrating through the flattening film 117.

As a material for the flattening film 117, an inorganic material such as SiO₂, a spin-on glass, SiN (Si₃N₄), and TaO (Ta₂O₅); an organic material such as a polyimide resin, an acryl resin, a photoresist material, and a black matrix material; and the like are usable. It is possible to select spin coating, CVD, vapor deposition, or the like depending on the material to be used. When necessary, the contact hole 118 is formed by a photolithography method using a photosensitive resin as the flattening layer or by forming the flattening layer on the whole surface and then performing dry etching, wet etching, or the like on the position corresponding to the TFT 120 formed below the flattening layer. The contact hole is filled with an electroconductive material afterward to be used for conduction with the pixel electrode to be formed above the flattening layer. A thickness of the flattening layer is not particularly limited insofar as the TFT, condenser, wiring, and the like formed below the flattening layer are covered by the flattening layer, and a thickness of several micrometers, namely about 3 μm, for example, is sufficient.

Hereinafter, a process for forming an organic layer, a cathode, and a sealing layer on the TFT substrate 1 will be described.

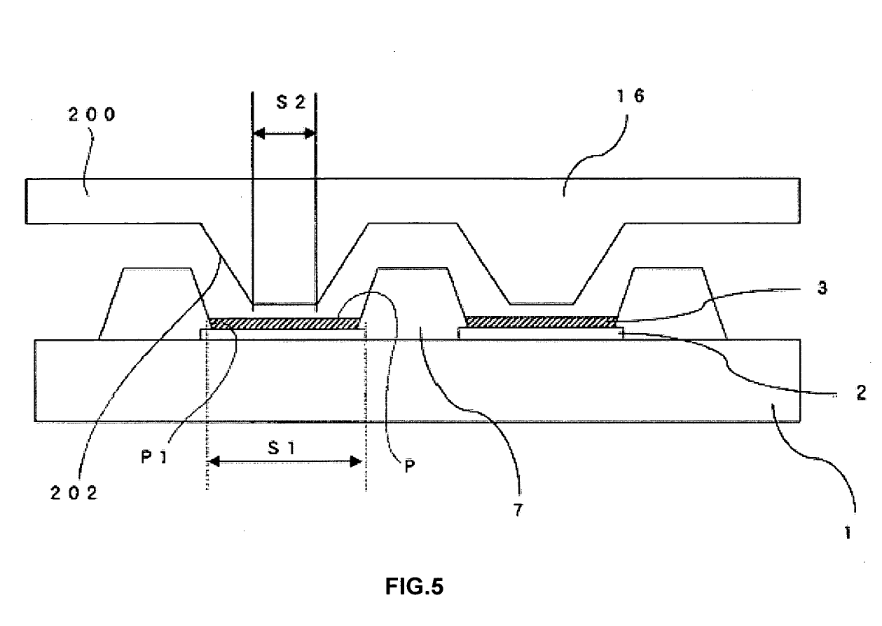

In the TFT substrate 1, the pixels P (see FIG. 5) are partitioned by the partitions 7 formed from an insulating material such as polyimide, so that apertures in the form of matrix are formed on the respective pixel electrodes (first electrodes 2).

The positive hole transport layer is firstly formed by using the TFT substrate 1.

Examples of a positive hole transport material to be used for forming the positive hole transport layer include a polyaniline derivative, a polythiophene derivative, a polyvinylcarbazole (PVK) derivative, a mixture (PEDOT/PSS) of poly(3,4-ethylenedioxythiophene) (PEDOT) or the like and polystyrene sulfonic acid (PSS); and the like. The material is dissolved or dispersed into a solvent to obtain a positive hole transport material ink, and it is possible to form a thin film by coating the whole surface with the ink by spin coating.

An organic light emitting layer is formed after forming the positive hole transport layer.

Examples of an organic light emitting material for forming the organic light emitting layer include those obtainable by dispersing a light emitting dye such as those of coumarin-based, perylene-based, pyrane-based, anthrone-based, porphyrene-based, quinacridone-based, N,N′-dialkyl-substituted quinacridone-based, naphthalimide-based, N,N′-diaryl-substituted pyrrolopyrrole-based, and iridium complex-based into a polymer such as polystyrene, polymethylmethacrylate, and polyvinylcarbazole; a high molecular material such as those of polyarylene-based, polyarylenevinylene-based, and polyolefin-based; and the like.

It is possible to obtain an organic light emitting ink by dissolving or dispersing any one of these organic light emitting materials into a solvent. Examples of the solvent to be used for dissolving or dispersing the organic light emitting material include toluene, xylene, acetone, anisole, methylethylketone, methylisobutylketone, cyclohexanone, and the like, which may be used alone or in combination. Among the above, the aromatic organic solvent such as toluene, xylene, and anisole are suitably used in view of solubility of the organic light emitting materials.

It is possible to form the organic light emitting layer by a relief process using a water-developable resin relief plate (relief plate).

In this invention, examples of a water-developable photosensitive resin for forming the resin plate include those containing a hydrophilic polymer, a so-called crosslinking monomer which is a monomer containing an unsaturated linkage and a photopolymerization initiator in the composition. In such water-developable photosensitive resin, polyamide, polyvinyl alcohol, a cellulose derivative, or the like is used as the hydrophilic polymer. Examples of the crosslinking monomer include methacrylates having a vinyl linkage, and examples of the photopolymerization initiator include an aromatic carbonyl compound. Among the above, the polyamide-based water-developable photosensitive resin is suitably used in view of printability.

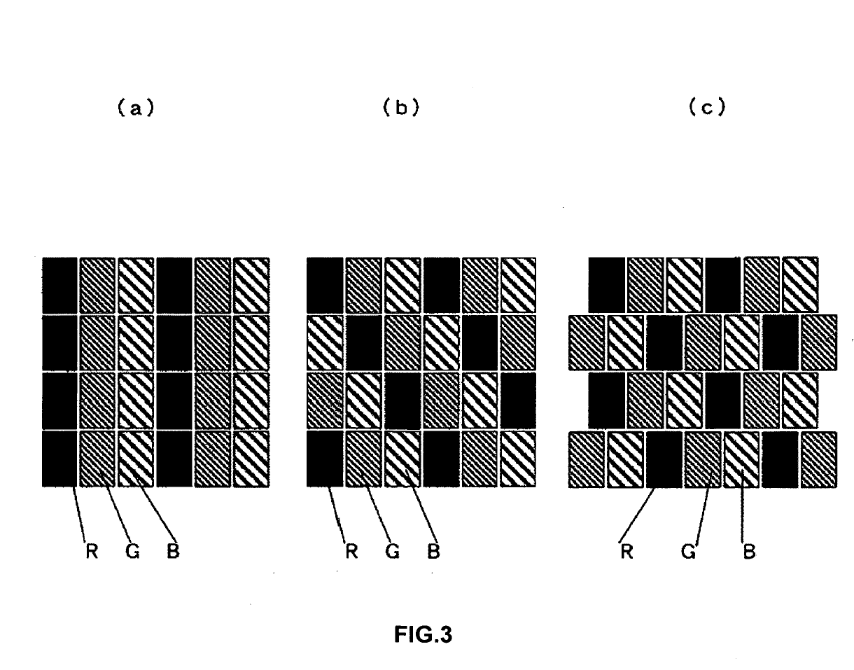

FIG. 3 is an illustration of alignments of pixels, wherein (a) shows a stripe alignment, (b) shows a mosaic alignment, and (c) shows a delta alignment. In FIG. 3, each of R, G, and B indicates a pixel in the color.

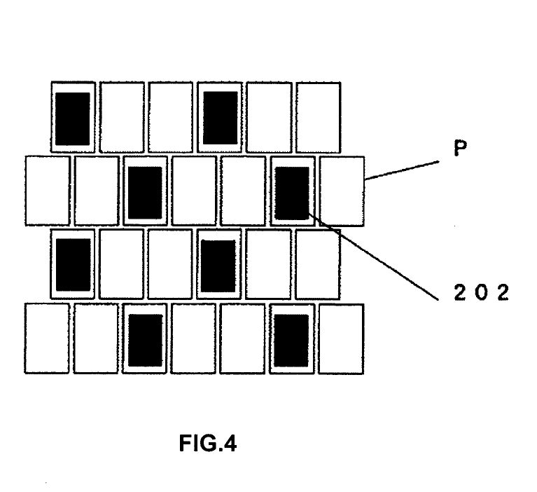

FIG. 4 is an illustration of positional relationship between the pixel alignment and projections (dots) of a plate in the delta alignment.

FIG. 5 is an illustrative sectional view showing the TFT substrate and the relief plate.

As shown in FIGS. 3, 4, and 5, the relief plate (resin relief plate) 16 of this invention has the projections 202 in accordance with the pixels P for which R, G, and B are arranged in the delta alignment and in the form of dots corresponding to the alignment for one of the colors.

More specifically, the resin relief plate 16 has the plural projections 202 in the form of dots corresponding to the pixels P of any one of colors among the pixels P respectively corresponding to R, G, and B, and an area S2 of an apical surface of each of the projections 202 is 70% to 90% of an area S1 of a bottom surface of an aperture P1 of each of the pixels P.

It is preferable that the area S2 of the apical surface of the projection 202 is as small as possible with respect to the area S1 of the pixel aperture (opening) P1 in view of easiness in adjusting a positional shift. However, when the area S2 is too small, an ink transfer amount becomes insufficient to fail to supply the ink in an amount sufficient for spreading over the whole pixels or to fail to achieve a predetermined film thickness. Also, in order to ensure a predetermined ink transfer amount, wettability of the relief plate 16 to the ink is important, and, as a result of various experiments, it was found that a preferable contact angle of a surface of the plate to the ink is 10 degrees or less.

The relief plate 16 will be described in more detail.

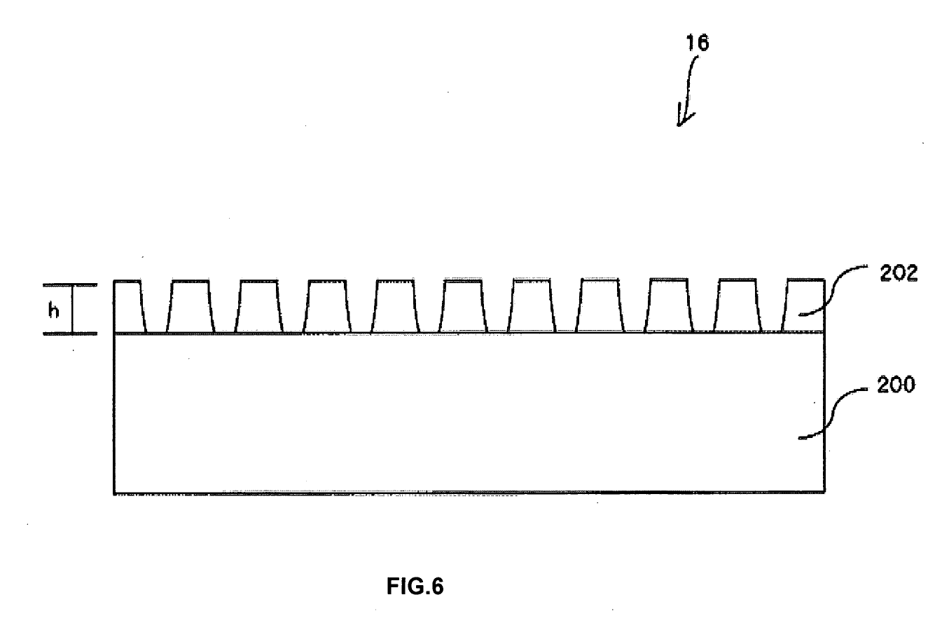

FIG. 6 is an illustrative sectional view of the resin relief plate 16 of this invention.

The resin relief plate 16 to be used for forming the organic light emitting layer by the relief process in this invention has a platy base material 200, and the plural projections 202 are formed from a synthetic resin on either one of surfaces in a direction of thickness of the base material 200. Each of the projections 202 is formed independently from the adjacent projections 202, and, in other words, not continued from the adjacent projections 202. Therefore, as compared to a conventional plate wherein the adjacent projections are continuous and integrated into a resin layer, it is possible to greatly suppress a shift in positional accuracy otherwise caused by modification of the resin forming the projections, thereby enabling high definition patterning.

As used herein, “Each of the projections 202 is formed independently from the adjacent projections 202” means that the projections 202 are separated from one another, and, more specifically, a portion from a rear end to a front end of each of the projections 202 is not in contact with but separated from the adjacent projections 202 on the base material 200.

The base material 200 to be used for the resin relief plate 16 is formed from a material that is different from the synthetic resin material forming the projections 202.

As the base material 200, those having mechanical strength sufficient for printing are used, and examples thereof include a known synthetic resin such as polyethylene, polystyrene, polybutadiene, polyvinyl chloride, polyvinylidene chloride, polyvinyl acetate, polyamide, polyethersulfone, polyethylenetelephthalate, polyethylenenaphthalate, polyethersulfone, and polyvinyl alcohol; a known metal such as iron, copper, and aluminum; or a stacked body thereof. As the base material 200 constituting the resin relief plate to be used in this invention, sufficient rigidity for suppressing dimensional change of the resin portion and resistance to dimensional change are required. Also, it is preferable to have high resistance to the organic solvent contained in the organic light emitting ink. Therefore, the metal material is suitably used as the material for the base material 200.

Also, in view of processability and economy, a steel base material and an aluminum base material are suitable among the base materials made from metal.

Further, a dimensional change due to a temperature change is considered to be one of the causes for the dimensional change of the resin plate. Since it is possible to suppress the dimensional change of the plate by using the base material 200 that is less subject to the temperature dimensional change, it is desirable to use the base material 200 having a small thermal expansion coefficient.

The thermal expansion coefficient of the material to be used for the base material 200 may preferably be 2.0×10⁻⁵/K or less, more preferably 3.0×10⁻⁶/K or less. The metals such as iron have a sufficiently lower thermal expansion coefficient as compared to a polyester film having a thermal expansion coefficient of 1.0×10⁻⁴/K or more and are suitable for the base material 200 of the resin plate of this invention in view of the thermal expansion coefficient.

The thermal expansion coefficient of iron is 1.2×10⁻⁵/K. Further, an alloy of iron and nickel has a thermal expansion rate lower than that of iron, and, particularly, an alloy containing 64% of iron and 36% of nickel is the most suitable alloy since it exhibits a thermal expansion rate that is 1/10 or less of that of general metals.

As the resin for forming the projections 202 in the resin relief plate in this invention, those having solvent resistance to the organic light emitting ink are used, and it is possible to select one or more from rubbers such as a nitrile rubber, a silicone rubber, an isoprene rubber, a styrene butadiene rubber, a butadiene rubber, a chloroprene rubber, a butyl rubber, an acrylonitrile rubber, an ethylene propylene rubber, an urethane rubber; synthetic resins such as polyethylene, polystyrene, polybutadiene, polyvinyl chloride, polyvinylidene chloride, polyvinyl acetate, polyamide, polyethersulfone, polyethylenetelephthalate, polyethylenenaphthalate, polyethersulfone, polyvinyl alcohol, and copolymers thereof; cellulose derivatives; fluorine-based resins such as a fluorine-based elastomer, polytetrafluoroethylene, polyvinylidene fluoride, polyhexafluorovinylidene, and copolymers thereof.

Among the above, the water-soluble resin materials such as polyamide, polyvinyl alcohol, and the cellulose derivatives are suitably used in view of good resistance to the solvents used for the organic light emitting ink.

As the solvents for the organic light emitting ink, the aromatic organic solvents are suitably used. The solubility parameter (hereinafter referred to as SP value) of toluene which is the representative aromatic organic solvent is 8.9, and the SP value of xylene is 8.8. The SP values of polyamide (nylon), polyvinyl alcohol, and cellulose that are the water-soluble resin materials are 13.6, 12.6, and 15.7, respectively, and it is apparent that the water-soluble resins have sufficient resistance to the aromatic organic solvents such as toluene and xylene in view of the difference between the SP values of the water-soluble resin materials and the aromatic organic solvents.

Also, in view of processability, it is desirable to use a photosensitive resin as the resin material. For example, the photosensitive resin having a polymer, a monomer containing an unsaturated linkage, and a photopolymerization initiator in the composition may be used. As the polymer, it is preferable to use a water-soluble polymer for the reasons stated in the foregoing, and it is possible to use polyamide, polyvinyl alcohol, a cellulose derivative, and an acryl resin. Also, it is possible to use methacrylates having a vinyl linkage, for example, as the monomer containing the unsaturated linkage, and it is possible to use an aromatic carbonyl compound, for example, as the photopolymerization initiator.

A thickness h of the projections 202 may preferably be from 0.01 mm to 1 mm. In the case where the thickness is less than 0.01 mm, it is difficult to achieve a uniform thickness of the resin layer as well as to achieve film thickness uniformity of the organic light emitting layer. Also, in the case where the thickness is 1 mm or more, influence to be exerted by modification of the resin layer on the high definition patterning is increased. Further, since strength of the independent pattern portion becomes insufficient, a breakage of the resin layer can occur when a strong force is externally applied.

Hereinafter, a method of forming the resin relief plate by using a photosensitive resin as the resin and by forming resin projections employing photolithography will be described.

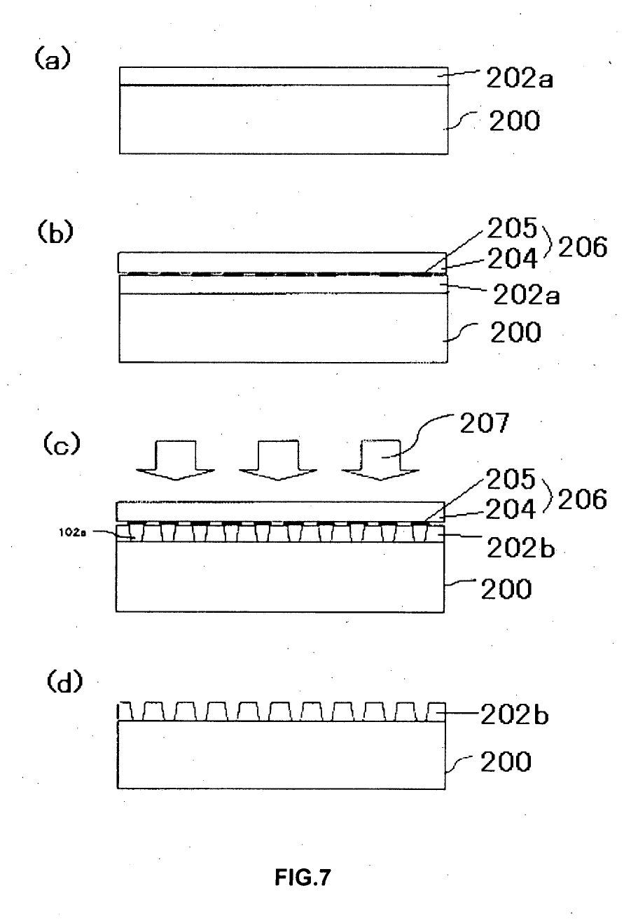

Shown in FIG. 7 is an illustrative sectional view of the resin relief plate production method.

As shown in FIG. 7(a), a plate material having the base material 200 and a photosensitive resin 202a formed on whole surface of the base material 200 is prepared.

As shown in FIG. 7(b), a photomask 206 having light shielding portions and light transmitting portions and a pattern formed by the light transmitting portions is disposed on the photosensitive resin 202a. The photomask has such a structure that the light shielding portions 205 formed from a chromium thin film, for example, are patterned on a light transmitting glass 204, and the portions on which the chromium thin film is formed are used as the light shielding portions, while the portions on which the chromium thin film is not formed are used as the light transmitting portions.

As shown in FIG. 7(c), light exposure is performed in such a manner that the plate material is irradiated with active energy beam 207 such as ultraviolet ray via the photomask. In the light exposure, portions 202b that are irradiated with the active energy beam passed through the light transmitting portions of the photomask are cured.

The photomask is then removed from the resin relief plate to perform development. The uncured portion that has not been irradiated with the light is eliminated by the development to obtain the resin relief plate of this invention shown in FIG. 7(d). In the development, water is used as a development liquid in the case where the water-developable resin relief plate of which the uncured portion can be dissolved and eliminated with water is used. Also, after the development, baking or post-light exposure may be performed for the purpose of further curing the resin layer.

It is possible to form the projections 202 of the resin relief plate of this invention by a method other than the photolithography, such as a laser abrasion method and a cutting work.

As the printing press to be used for forming the organic light emitting layer, relief plate printing presses of a system for printing on a flat plate are usable, and the following printing press is desirable.

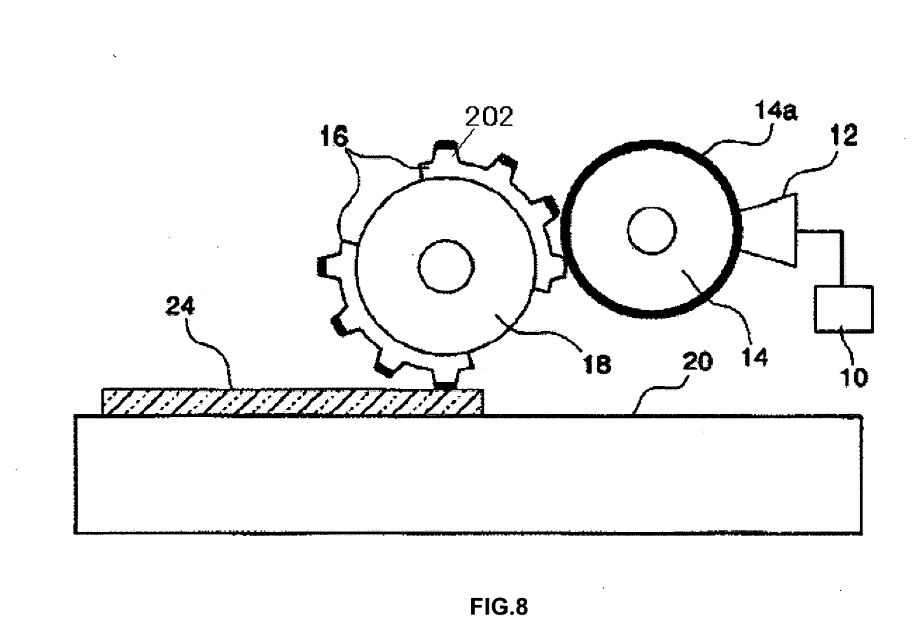

FIG. 8 is a schematic diagram showing the relief plate printing press.

The relief plate printing press has an ink tank 10, an ink chamber 12, an anilox roller 14, and a plate cylinder 18 to which the resin plate 16 is attached. The ink tank 10 houses the organic light emitting ink diluted with a solvent, and the organic light emitting ink is drawn from the ink tank 10 to the ink chamber 12. The anilox roller 14 rotates with being in contact with an ink supply unit of the ink chamber 12 and the plate cylinder 18.

With the rotation of the anilox roller 14, the organic light emitting ink 14a supplied from the ink chamber 12 is uniformly retained on a surface of the anilox roller 14 and then transferred to the projections 202 of the resin relief plate 16 attached to the plate cylinder 18 in a uniform thickness.

Further, the substrate to be printed 24 (TFT substrate 1) is moved to a print start position with a position thereof being adjusted by a position adjustment mechanism of the pattern of the projections 202 of the resin relief plate 16 fixed on a slidable substrate platform and the pattern of the substrate to be printed 24 and then further moved with the projections 202 of the resin relief plate 16 being in contact with the substrate to be printed 24 in accordance with the rotation of the plate cylinder 18, so that patterning is performed on a predetermined position of the substrate to be printed 24 which is placed on a stage 20, thereby transferring the organic light emitting ink 14a.

As shown in FIG. 1, after the formation of the organic light emitting layers (red (R) organic light emitting layer 41, green (G) organic light emitting layer 42, blue (B) organic light emitting layer 43), the cathode layer (second electrodes 5) is formed.

As a material for the cathode layer (second electrodes 5), those suitable for light emitting property of the organic light emitting layers may be used, and examples thereof include a single metal such as lithium, magnesium, calcium, ytterbium, and aluminum; an alloy of the single metal and a stable metal such as gold and silver; and the like. Also, an electroconductive oxide of indium, zinc, tin, or the like may be used. Examples of a method for forming the cathode layer (second electrodes 5) include a method using a mask and employing the vacuum vapor deposition.

Lastly, the organic EL component parts are tightly sealed for the purpose of protection from external oxygen and moisture by using a glass cap 8 and an adhesive agent 9 to obtain an organic EL display panel.

According to this invention, in the method of forming the light emitting layers for the respective pixels of the TFT substrate by using the resin relief plate having the projections in the form of dots, it is possible to achieve an effect of making the positioning in the printing direction easier by using the relief plate provided with the projections in the form of dots each having the area smaller than that of the aperture of each of the pixels formed by the partitioning by the partitions since the use of such relief plate prevents the dots of the plate from being shifted from the apertures of the pixels when the printing position is shifted somewhat. Therefore, the pattern printing of the light emitting layer in the form of dots is realized, thereby making it possible to form the light emitting layers of the organic EL display having the delta RGB alignment or the mosaic RGB alignment by printing.

### EXAMPLE 1

Hereinafter, Examples of this invention will be described.

In this example, with the use of a TFT substrate 1 on which the pixel electrodes (first electrodes 2), takeoff electrodes, an insulating layer formed from a SiNx film for protecting the TFT circuit, and an insulating layer formed from polyimide for partitioning pixels P and functioning as partitions 7 of the pixels are formed, an organic EL display panel of an active matrix type delta alignment was obtained by forming positive hole transport layers 3, light emitting layers, and cathodes (second electrodes 5) on the TFT substrate 1 in this order.

A bottom surface of an aperture P1 of each of the pixels partitioned by the partitions 7 was in the form of a rectangle having a length of 120 μm and a width of 40 μm.

The positive hole transport layers 3 were formed by obtaining a thin film of a film thickness of 50 nm by coating the TFT substrate 1 with a water dispersion of PEDOT/PSS by spin coating.

The light emitting layers were printed by a relief print process by using organic light emitting inks of three colors of R, G, and B obtained by dissolving each of polyfluorene-based R material, G material, and B material as organic light emitting material to toluene at a concentration of 1% and coating the pixels with R, G, and B in the delta alignment by using a relief plate having dots.

For the printing of the light emitting layers, water-developable type photosensitive resin plate was used. A contact angle of the light emitting material ink to the surface of the plate was 10 degrees or less.

The cathode layer (second electrodes 5) made from Ca and Al was formed by vacuum vapor deposition employing resistive heating vapor deposition on the light emitting layers. Lastly, the organic EL component parts were tightly sealed by using a glass cap 8 and an adhesive agent 9 for the purpose of protection from external oxygen and moisture, to thereby obtain an element panel for organic EL display.

The takeoff electrodes at the anode side and the cathode side connected to the pixel electrodes are disposed on a rim of a display unit of the thus-obtained panel, and lighting and display of the panel were confirmed by connecting the takeoff electrodes to a driving device via a driver to check a light emission state.

In Example 1, the size of an apical surface of each of the projections 202 of the plate was set to a length of 110 μm and a width of 38 μm, so that a ratio of an area S2 of the apical surface of the dot (projection 202) of the plate to an area S1 of the bottom surface of a pixel aperture P1 is 87%.

Since the bottom surface of each of the apertures P1 of the pixels partitioned by the partitions was in the form of the rectangle having the length of 120 μm and the width of 40 μm, a positional shift of 10 μm or less in the printing direction is within a tolerable range.

Also, a thickness of each of the dried light emitting material inks measured after the printing was 76 nm, and a film thickness was uniform in each of the pixels.

### EXAMPLE 2

In Example 2, the size of the apical surface of the projection 202 of the plate was changed to a length of 90 μm and a width of 38 μm, so that the ratio of the area S2 of the apical surface of the dot (projection 202) of the plate to the area S1 of the bottom surface of the pixel aperture P1 becomes 71%. Since the bottom surface of each of the apertures P1 of the pixels partitioned by the partitions 7 was in the form of the rectangle having the length of 120 μm and the width of 40 μm, a positional shift of 30 μm or less in the printing direction is within a tolerable range.

An organic EL display panel was prepared in the same manner as in Example 1 except for the above-described change.

A thickness of each of the dried light emitting material inks measured after the printing was 68 nm, and a film thickness was uniform in each of the pixels.

### COMPARATIVE EXAMPLE 1

In Comparative Example 1, the size of the apical surface of the projection 202 of the plate was changed to a length of 120 μm and a width of 40 μm, so that the size of the dot is the same as that of the bottom surface of each of the apertures P1 of the pixels partitioned by the partitions 7.

Accordingly, since the projections 202 of the plate overlaps with the partitions 7 in the case where a slightest positional shift in the printing direction occurs, there is very little tolerance for the positional shift.

An organic EL display panel was prepared in the same manner as in Example 1 except for the above-described change.

A thickness of each of the dried light emitting material inks measured after the printing was 78 nm, and a film thickness was nonuniform in each of the pixels.

### COMPARATIVE EXAMPLE 2

In Comparative Example 2, the size of the apical surface of the projection 202 of the plate was changed to a length of 70 μm and a width of 38 μm, so that the ratio of the area S2 of the apical surface of the projection 202 of the plate to the area S1 of the bottom surface of the pixel aperture P1 becomes 55%.

Since the bottom surface of each of the apertures P1 of the pixels partitioned by the partitions 7 was in the form of the rectangle having the length of 120 μm and the width of 40 μm, a positional shift of 50 μm or less in the printing direction is within a tolerable range.

An organic EL display panel was prepared in the same manner as in Example 1 except for the above-described change.

A thickness of each of the dried light emitting material inks measured after the printing was 50 nm, and a film thickness was nonuniform in each of the pixels.

### REFERENCE EXAMPLE 1

In Reference Example 1, the size of the apical surface of the projection 202 of the plate was changed to a length of 110 μm and a width of 38 μm, so that the ratio of the area S2 of the apical surface of the projection 202 of the plate to the area S1 of the bottom surface of the pixel aperture P1 becomes 87%.

Since each of the apertures P1 of the pixels partitioned by the partitions 7 was in the form of the rectangle having the length of 120 μm and the width of 40 μm, a positional shift of 10 μm or less in the printing direction is within a tolerable range.

Further, the plate used as the relief plate was changed to that containing a fluorine-based component to perform the light emitting layer printing.

A contact angle of a surface of the plate to the light emitting material ink was 40 degrees.

A thickness of each of the dried light emitting material inks measured after the printing was 40 nm, and a film thickness was nonuniform in each of the pixels.

TABLE 1
Results of Examples and Comparative Examples

| | | Contact Angle | | Film | |
|---|---|---|---|---|---|
| | Area Ratio of | of Light | | Thickness | |
| | Plate | Emitting | | Distribution in | Printing |
| | Projection to | Material Ink to | Film | Each of | Positional |
| | Pixel Aperture | Plate Surface | Thickness | Pixels | Accuracy |
| Ex. 1 | 87% | <10 degrees | 76 nm | ∘ | ∘ |
| Ex. 2 | 71% | <10 degrees | 68 nm | ∘ | ∘ |
| Comp. Ex. 1 | 100% | <10 degrees | 78 nm | x | x |
| Comp. Ex. 2 | 55% | <10 degrees | 50 nm | x | ∘ |
| Ref. Ex. 1 | 87% | 40 degrees | 40 nm | x | ∘ |

For film thickness distribution and printing positional accuracy,
∘ means good, and x means no good.

In Table 1, results of evaluations of film thickness distribution in each of the pixels and printing positional accuracy of the organic EL panels prepared by Examples 1 and 2, Comparative Examples 1 and 2, and Reference Example 1 are shown.

As is apparent from Table 1, since the area S2 of the apical surface of the projection 202 of the plate is smaller than the area S1 of the bottom surface of the pixel aperture P1 in Examples 1 and 2, the printing positional accuracy has the tolerance, and the accuracy in printing direction which is difficult to improve is good.

Also, since the positional shift is eliminated, the film thickness distribution in each of the pixels is good, and the film thickness is within the range of 60 to 80 nm which is the optimum film thickness range of the light emitting layer.

In contrast, in Comparative Example 1, since the area S2 of the apical surface of the projection 202 of the plate is the same as the area S1 of the bottom surface of the pixel aperture P1, the positional accuracy has no tolerance, and the positional shift in printing direction was observed in the printed panel. Also, due to the influence of the positional shift, the film thickness distribution in each of the pixels was nonuniform.

In Comparative Example 2, since the area S2 of the apical surface of the projection 202 of the plate is sufficiently smaller than the area S1 of the bottom surface of the pixel aperture P1, no problem was detected with the positional accuracy. However, since the area S2 is too small, an ink transfer amount is small, and the film thickness distribution in each of the pixels was deteriorated due to the insufficient ink transfer amount. Also, the film thickness is 50 nm which is out of the optimum range.

In Reference Example 1, the contact angle of the plate to the light emitting material ink is 40 degrees which is high, so that an ink transfer amount is reduced to reduce the film thickness, resulting in the unsatisfactory film thickness distribution in each of the pixels.

From the foregoing, it is revealed that it is necessary to use a plate which is capable of achieving a relatively large contact angle with ink and a sufficient ink transfer amount in the case of printing by using the plate having the projections 202 each having the apical surface area which is smaller than the area S1 of the bottom surface of the pixel aperture P1.

What is claimed is:

1. A method for producing an organic EL display panel of active matrix type in which
a plurality of pixels, formed of pixels corresponding to R, pixels corresponding to G, and pixels corresponding to B, are aligned on a substrate with regularity,
an RGB alignment with which the pixels corresponding to R, G, and B are formed on the substrate is a delta alignment or a mosaic alignment, and
the pixels are partitioned by partitions each formed for and around each of the pixels on the substrate, comprising:
forming a light emitting layer by transferring an ink obtainable by dissolving or dispersing an organic light emitting material into a solvent on the pixels for each of colors of R, G, and B by using a relief plate, wherein
the plate comprises a plurality of projections in the form of dots corresponding to the pixels for any one of the colors among the pixels corresponding to R, G, and B, and
an area of an apical surface of each of the projections is 70% to 90% of an area of a bottom surface of an aperture of each of the pixels.

2. The organic EL display panel production method according to claim 1, wherein a contact angle of the ink to the relief plate is 10 degrees or less.

3. The organic EL display panel production method according to claim 1, wherein the relief plate is formed from a water-developable photosensitive resin relief plate.

4. The organic EL display panel production method according to claim 1, wherein
the relief plate has a base material in the form of a plate; and
the projections are formed on either one of surfaces in a thickness direction of the base material and from a synthetic resin material in such a fashion that the projections are separated from one another.

5. The organic EL display panel production method according to claim 4, wherein the base material is formed from a material different from the synthetic resin material for forming the projections.

6. The organic EL display panel production method according to claim 5, wherein the material for forming the base material is a metal material.

7. The organic EL display panel production method according to claim 1, wherein the substrate is a TFT substrate on which a thin film transistor is formed for each pixels.
